(19) United States
(12) Patent Application Publication
(10) Pub. No.: US 2017/0174046 A1
(43) Pub. Date: Jun. 22, 2017

(54) METHOD AND DEVICE FOR STARTING AN AIR EXCHANGE OPERATION

(71) Applicant: FORD GLOBAL TECHNOLOGIES, LLC, Dearborn, MI (US)

(72) Inventors: Volker Scheer, Roetgen (DE); Marcel Mathissen, Würselen (DE); Rainer Vogt, Aachen (DE)

(21) Appl. No.: 15/358,720

(22) Filed: Nov. 22, 2016

(30) Foreign Application Priority Data
Dec. 16, 2015 (DE) 102015225382.1

(51) Int. Cl. B60H 1/24; B60H 3/06; B60H 1/00

(52) U.S. Cl. CPC B60H 1/248; B60H 1/00821; B60H 3/06; B60H 1/0065; B60H 2001/00607

(57) ABSTRACT

The document relates to a method and a device for starting an air exchange operation of a ventilation, heating and/or air-conditioning system which feeds recirculation air and/or fresh air to a space for at least one person. The air exchange operation is started if the person activates a dedicated operator control element, provided with a characteristic symbol for air exchange operation, and includes appreciably increasing previously applicable setting values both with respect to the portion of fresh air in the air fed to the space and also for an air flow targeted at least one person in the vehicle.

### TECHNICAL FIELD

This document relates to a method and to a device for starting an air exchange operation of a ventilation, heating and/or air-conditioning system.

### BACKGROUND

Stale air accumulates unpleasantly in vehicle passenger compartments when there is little supply of fresh air and/or in a recirculation air operating mode. This situation can occur because the user has manually set an insufficient fresh air supply or because the user has selected an automatic operating mode of the air-conditioning system and there are particular additional circumstances, e.g. a low velocity. In an automatic operating mode there can be provision that the air-conditioning system automatically ensures earlier or later that there is more exchange of air, but the intensity of an automatically started air exchange operation is limited for reasons of comfort, with the result that in this case situations can also occur in which at some point the air appears stale to the user.

If the user wishes to refresh the air by exchanging the passenger compartment air with fresh air, there are various manual setting possibilities available to him, e.g. by intensifying the blower air flow, setting a relatively low temperature set-point value of the air-conditioning system or a change in the degree of opening of blower outlet openings. For an effective exchange of air, the user will frequently have to change multiple settings, and this can lead to the driver being distracted, and can also lead to settings in which the recirculation air portion is set relatively high because the air-conditioning system is set primarily to optimizing power, with the result that the exchange of air does not take place quickly enough in order to alleviate the user's discomfort.

Of course, the user also has the option of opening windows, but this allows unfiltered, frequently dusty air and possibly also rain or sand to enter the passenger compartment. In the case of hot, humid ambient air or in the case of cold ambient air, this is also very uncomfortable, and in cases in which the air-conditioning system switches automatically into a recirculation air operating mode, this mode is unnecessarily loaded by the opening of windows. Furthermore, the noise level from the outside is increased unpleasantly.

U.S. Pat. No. 6,758,739 B1 discloses a generic method for starting an air exchange operation in a motor vehicle, wherein the air exchange operation is started automatically if sensors detect that the air quality in the passenger compartment has worsened objectively. However, any objective parameters for the air quality rarely correspond to the subjective impression of freshness of vehicle occupants, which impression varies greatly from one person to another.

EP 0 465 491 B1 discloses a method of the generic type for starting an air exchange operation in a motor vehicle, wherein, in settings of rotary knobs of a central operator control unit which are assigned to certain specific operating modes of the air-conditioning system, a heating air exchanger is bypassed with a fresh air bypass and therefore relatively cool air is directed to the central level of the vehicle. This is also aimed at providing a subjective impression of freshness for vehicle occupants, but in the process a large amount of unfiltered fresh air passes into the passenger compartment. The operator must also firstly know which of the many rotary knob settings he has to select.

EP 1 223 059 B1 discloses a motor vehicle air-conditioning system, the recirculation air portion being set automatically during the ventilation as a compromise between the efficiency of the air-conditioning and the air humidity loading on the basis of the measured air humidity. However, as already stated, objective parameters for the air quality often vary from the subjective impression of freshness which vehicle occupants have.

It is an object to provide a method and a device for starting an air exchange operation of a ventilation, heating and/or air-conditioning system which permits users to eliminate in a particularly simple, rapid and effective fashion a sensation of discomfort owing to air which is felt to be stale.

This object is achieved by means of a method and a device for starting an air exchange operation of a ventilation, heating and/or air-conditioning system having the features described herein. Those features can be combined with one another in any desired technically appropriate fashion and therefore give rise to further refinements of the invention.

An air exchange operation is started if the person activates a dedicated operator control element, provided with a characteristic symbol, for air exchange operation. In this case, previously applicable setting values, both with respect to the portion of fresh air in the air and also fed to the space for an air flow targeted at at least one person in the vehicle, are appreciably increased.

The method and apparatus therefore make available a particular “freshness” function which is formed by an air flow which is changed in terms of e.g. quantity and temperature with as much clean external air as possible. This is particularly aimed at the subjective impression of vehicle occupants, because already an impression of relatively strong air movements usually gives rise to a certain impression of freshness.

In one preferred embodiment, a setting value for the portion of fresh air which is applicable before the activation is increased in such a way that the ambient air is exchanged as quickly as possible with filtered fresh air without significantly adversely affecting the comfort of the vehicle occupants. This combines the specified subjective aspect with an objective aspect, specifically the cleanness of the introduced air in terms of loading with pollutants and the like.

The air exchange operation is preferably carried out by changing setting values for the temperature and/or intensity of the air flow targeted at the at least one person, which are applicable before the application, in such a way that a drop in temperature and an increase in intensity which can be clearly perceived by the person takes place which generates an objective and subjective impression of a supply of fresh air, without significantly adversely affecting the comfort of the person. This impression is preferably strengthened by the fact that the air flow is directed tangentially at the head and chest of the person.

The air exchange operation can be ended by virtue of the fact that the operator control element for the air exchange operation is activated once more, or otherwise automatically after the expiry of a preset time period, with the setting values being reset in each case to the previously applicable values.

The dedicated operator control element for starting an air exchange operation can be any control button such as e.g. a knob or a pushbutton key or else part of a touch-sensitive screen. The control button is provided with the characteristic symbol which is e.g. impressed or printed thereon or which is displayed on a screen.

A symbol in which one to four curved arrows are arranged in a common circle is known as a symbol for certain operating modes of many devices. Such symbols are borrowed from computer technology with a meaning of e.g. the refreshing of web contents. Such symbols are not very suitable as symbols for the exchange of air, since this would require a high abstraction capacity of the viewer. In the case of ventilation, heating and/or air-conditioning systems in motor vehicles, such symbols are therefore used for a recirculation air mode in which the passenger compartment is enclosed climatically and the air is circulated only within the passenger compartment.

A more suitable symbol for starting and stopping an air exchange operation would be e.g. a stylized plan view of the vehicle in which the fresh air which is fed in from the front and the used air which is discharged to the rear are represented by straight arrows.

A particularly characteristic and particularly intuitive symbol for starting and stopping an air exchange operation is also made available which is composed of two approximately U-shaped arrows, one limb of which is in each case longer than the other. The first arrow points toward the center of the semicircular section of the second arrow, and the start of the second arrow is located approximately in the center of the semicircular section of the first arrow.

The symbol preferably has an approximately square virtual outline in which the first U-shaped arrow starts top left with a straight horizontal section which is adjoined by the semicircular section whose radius is approximately a third of the height of the outline and which ends with an arrow tip. The second U-shaped arrow then starts with a straight section which extends in the direction indicated by the arrow tip of the first arrow and which is adjoined by the semicircular section of the second arrow whose radius is also approximately a third of the height of the outline and which is adjoined by a straight section which ends bottom right in the outline with an arrow tip.

In the symbol, the first upper arrow naturally represents the fresh air which is fed in from the front, and the second lower arrow naturally represents the used air which is discharged to the rear, with the result that the meaning of the symbol is grasped intuitively by viewers.

In one preferred embodiment, the space which is to be ventilated, heated or air-conditioned is an essentially enclosed passenger compartment of a motor vehicle.

The method and device are suitable for ventilation, heating and/or air-conditioning systems in any vehicles including aircraft and watercraft. A particularly preferred purpose of use is in land vehicles and, in particular, motor vehicles. The symbol can be positioned on a device which is installed in the vehicle and/or can be located on a device which communicates with it such as e.g. a Smartphone, a smart watch, a radio vehicle key or some other remote control device, with the result that e.g. a vehicle owner can already start the air exchange operation from a distance. The method and device can, however, basically also be used in building ventilation systems.

### BRIEF DESCRIPTION OF THE DRAWING FIGURES

A description of exemplary embodiments on the basis of the drawings follows. In the drawings:

FIGS. 1a and 1b show a procedure for starting an air exchange operation of a motor vehicle air-conditioning system;

FIG. 2 shows an exemplary embodiment for a symbol for starting and stopping an air exchange operation; and

FIG. 3 shows a variant of the symbol for starting and stopping an air exchange operation.

### DETAILED DESCRIPTION

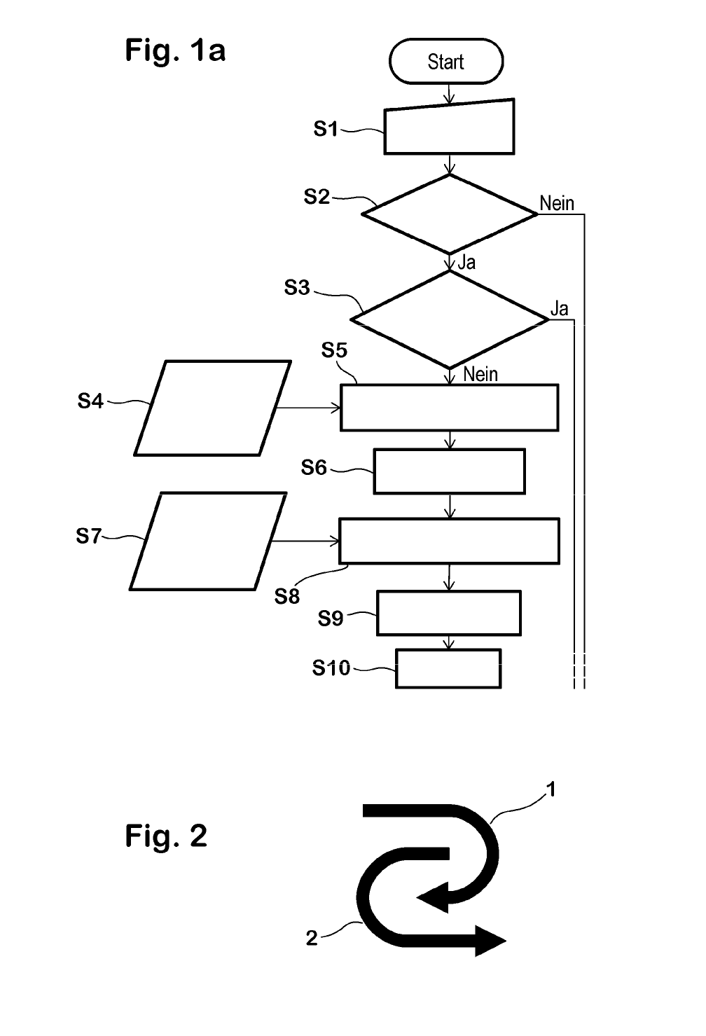

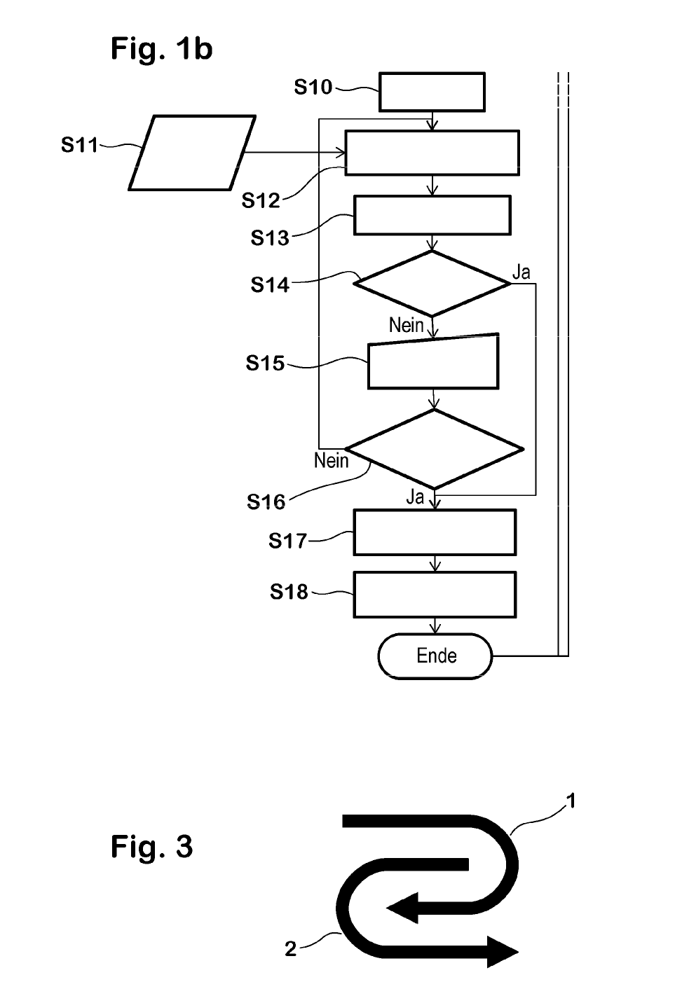

An exemplary embodiment of a procedure for starting an air exchange operation of a motor vehicle air-conditioning system will now be explained with reference to the flow chart which starts in FIG. 1a and continues in FIG. 1b.

In a loop which is run through repeatedly, in step S1 a dedicated operator control element for air exchange operation in the motor vehicle, referred to below as air refresh button, is presented to the vehicle occupant or occupants. In step S2, it is checked whether the air refresh button has been activated or not. As long as the air refresh button has not been activated, the procedure jumps over all the following steps and then starts anew.

If activation of the air refresh button is detected in step S2, it is checked in step S3 whether the air-conditioning system is in an operating mode which in any case involves feeding a large amount of fresh air or which has priority over an air exchange operation. Such operating modes are e.g. a maximum demisting operation or operation with a maximum cooling effect. If a prioritized operating mode is currently set, the procedure jumps over all the following steps and starts anew.

If it is detected in step S3 that the currently set operating mode of the air-conditioning system is compatible with an air exchange operation, in step S4 setting values which are read out e.g. via a CAN bus of the vehicle, for the currently set operating mode of the air-conditioning system, for the passenger compartment temperature and for which blower of the air-conditioning system is currently operating with which intensity levels and which outlet temperatures are stored in step S5. A superimposition window which indicates the selection of the operating mode of air refresh and details thereon and which optionally also permits the user to change individual parameters of this operating mode as desired are displayed on a screen in step S6.

In step S7, vehicle parameters and ambient parameters which are relevant for the air conditioning, such as e.g. the velocity, the temperature and relative humidity of the ambient air, intensity of the solar radiation etc., are read out via the CAN bus, and in step S8 optional setting values for the currently set operating mode of the air-conditioning system, for the passenger compartment temperature and for which blowers of the air-conditioning system are currently operating with which intensity levels and outlet temperatures are calculated taking into account the vehicle parameters and ambient parameters, and in step S9 the air-conditioning system is instructed to apply these setting values.

Optimum setting values are those which appreciably increase the portion of fresh air in the air supply to the space and, if appropriate, also an air flow targeted at the vehicle occupant or occupants, in order to exchange the ambient air as quickly as possible with fresh air, without significantly adversely affecting the comfort of the vehicle occupant or occupants. However, vehicle occupants are to clearly perceive that an air exchange operation is carried out now. For this purpose, air flows with somewhat lower temperatures and higher flow speeds than previously are directed in the targeted fashion at the vehicle occupant or occupants, in order to give them a significant impression of a supply of fresh air and to give them both objective and subjective relief if they are suffering from stuffy air. It is not a problem, but can even be favorable, if the blower or blowers produce more noise while operating now since even the feeling that something is being done can be beneficial.

In step S10, a timer for a maximum air exchange time is also started.

In step S11 (FIG. 1b), the current velocity and the current setting values for blowers and the operating mode of the air-conditioning system are read out and used in step S12 to calculate a “state of freshness” of the air in the passenger compartment, e.g. as a percentage portion of the newly input fresh air in the passenger compartment air or as a portion of the still present old air which decreases exponentially. Corresponding functions can be calculated in advance or determined empirically and can then be used to represent in step S13 the added fresh air and/or the still present old air graphically and/or numerically in the superimposition window shown in step S6, with the result that occupants can track the progressive exchange of air even better.

In step S14 it is checked whether the maximum air exchange time is exceeded. If it is, the system progresses to step S17. If not, in step S16 it is checked whether the air refresh button which is presented in step S15 has been activated again or not. If the air refresh button has not been activated again, the system returns to step S12.

If it is detected in step S16 that the air refresh button has been activated again, this is interpreted as being an instruction to end the air exchange operation. At the end of the air exchange operation in step S17, the setting values for the operating mode, passenger compartment temperature and for which blowers of the air-conditioning system are currently operating with which intensity levels and outlet temperatures are also reset to the values stored in step S5.

In step S18, it is indicated to the vehicle occupant in the superimposition window that the operating mode of air refresh has been ended, as a result of which the procedure is ended and started again from the beginning.

A dedicated air exchange function, which exchanges the air in the passenger compartment with fresh air which is directed with an increased flow speed at vehicle occupants, in particular onto their head and chest, is made available by means of a flow of filtered external air, possibly still with a certain portion of recirculation air. Users can easily start and stop the function.

In difficult situations, e.g. in the case of hot, humid external air, the function can limit the external air supply to a value at which a sufficient air-conditioning system operation is still possible, i.e. without producing relatively warm air or exceeding the power limits of the air-conditioning system.

When the function starts, some or all of the following air-conditioning settings are activated:
increased blower speed, optionally or, in particular, as a function of the previously set blower speed, the external air temperature and, if appropriate, the solar radiation;
lowered expulsion air temperature, optionally or, in particular, as a function of the previously set expulsion air temperature, the external air temperature and, if appropriate, the solar radiation;
selection of the active outlets for the expulsion air, optionally or, in particular, as a function of previously selected outlets, the external air temperature and, if appropriate, the solar radiation;
displaying of a screen menu which permits manual changing of parameters of the air exchange operating mode, whether this be a changeover between various provided basic setting combinations or the changing of individual parameters, e.g. percentage fresh air portion or recirculation air portion. For this purpose, the air exchange operating mode can also be made optionally or, in particular, as a function of previous selections, of the external air temperature, and of further parameters such as, e.g. the external air humidity, the solar radiation, the velocity and/or blower rotational speeds;
in any case, whether with or without a screen display, the starting and stopping of the air exchange operating mode and, if appropriate, also changes in parameters require fewer activation actions by the user;
the supplying of filtered and temperature-controlled fresh air instead of unfiltered non-temperature-controlled fresh air with an open window;
all the settings can also be made with a view to optimizing the air-conditioning operation within the power limit of the air-conditioning system;
changes in settings can be limited to the effect that a user who feels that the passenger compartment air is stuffy and therefore starts the air exchange operating mode, finds the changes generally pleasant, and not unpleasant;
the air exchange operating mode can still be made in a way which tends to be perceived by the user through moderately increased blower noise.

A numerical example is as follows:
given an external air temperature of 30° C., the air-conditioning system will operate with four opened air outlets on the dashboard, from a total of seven air outlets distributed in the vehicle, in the recirculation air mode with an expulsion temperature of 13° C. and a velocity of more than 70 km/h.
After the selection of the air exchange function, five of the seven air outlets are opened, specifically in addition one in the driver's door; the air-conditioning system then operates with 25% fresh air, and the expulsion temperature is lowered to 10° C.
When the air exchange function is deselected, previous settings are restored, either to the same values or under the control of the air-conditioning automatic system according to the user's specifications.

FIG. 2 shows a particularly characteristic and particularly intuitive symbol for the starting and stopping of an air exchange operation, with which symbol a start-stop button or a corresponding screen control button can be provided.

The symbol is composed of two approximately U-shaped arrows 1 and 2 which are interleaved one in the other and of which the arrow 1 represents the fresh air fed in from the front, and the arrow 2 represents the used air discharged to the rear. The arrow tips also indicate to the user that these air movements take place forcibly. This intuitive visual impression can be strengthened further by suitable coloring, e.g. by a green or blue arrow 1 for cool and clean fresh air and by a red arrow 2 for polluted, stale and/or warm waste air.

The configuration shown in FIG. 2 can be varied without changing the overall impression of the symbol, e.g. by moderate horizontal stretching, as illustrated in FIG. 3.

What is claimed:

1. A method for starting an air exchange operation of a ventilation, heating and/or air-conditioning system which feeds recirculation air and/or fresh air to a space for at least one person, comprising:
starting said air exchange operation by activating a dedicated operator control element, having a characteristic symbol, for air exchange operation; and
increasing previously applicable setting values both with respect to a portion of fresh air fed to the space and also for an air flow targeted at least one person in the space.

2. The method as claimed in claim 1, including increasing a setting value for the portion of fresh air which is applicable before activating the dedicated operator control element in such a way that ambient air is exchanged as quickly as possible with filtered fresh air without significantly adversely affecting comfort of the at least one person.

3. The method as claimed in claim 2, including changing setting values for a temperature and/or intensity of the air flow targeted at the at least one person, which are applicable before activating the dedicated operator control element, in such a way that a drop in temperature and an increase in intensity that can be clearly perceived by the at least one person takes place without significantly adversely affecting the comfort of the at least one person.

4. The method as claimed in claim 3, including achieving clear perceptibility of the increase in intensity by directing the air flow tangentially at a head and chest of the at least one person.

5. The method as claimed in claim 4, including ending the air exchange operation if the at least one person activates the operator control element for the air exchange operation once more, or after expiry of a preset time period, and resetting the setting values to the previously applicable values when the air exchange operation ends.

6. A device for starting an air exchange operation of a ventilation, heating and/or air-conditioning system which feeds recirculation air and/or fresh air to a space for at least one person, comprising:
a dedicated operator control element for starting an air exchange operation wherein the dedicated operator control element is configured in particular for carrying out the method as claimed in claim 1.

7. The device as claimed in claim 6,
wherein the dedicated operator control element is a control button which is provided with a symbol, wherein the symbol is composed of a first U-shaped arrow and a second U-shaped arrow, the first U-shaped arrow pointing toward the center of a first semicircular section of the second U-shaped arrow, and a start of the second U-shaped arrow being located approximately in a center of a second semicircular section of the first U-shaped arrow.

8. The device as claimed in claim 7,
wherein within an approximately square virtual outline of the symbol, the first U-shaped arrow starts top left with a first straight horizontal section which is adjoined by the second semicircular section having a first radius approximately a third of a height of the approximately square virtual outline and which ends with a first arrow tip, and the second U-shaped arrow starts with a second straight section which extends in a direction indicated by the first arrow tip of the first U-shaped arrow and which is adjoined by the first semicircular section with a second radius approximately a third of the height of the outline and which is adjoined by a second straight section which ends bottom right in the approximately square virtual outline with a second arrow tip.

9. The device as claimed in claim 8,
wherein the space is an essentially enclosed passenger compartment of a vehicle.
